(19) United States
(12) Patent Application Publication
(10) Pub. No.: US 2018/0364685 A1
(43) Pub. Date: Dec. 20, 2018

(54) METHOD FOR PROVIDING A GENERIC DIAGNOSIS MODEL

(71) Applicant: ENDRESS+HAUSER PROCESS SOLUTIONS AG, Reinach (CH)

(72) Inventors: Johannes SPRENGER, Lörrach (DE); Fabian BIHLER, Rheinfelden (DE); Michael KALBERMATTER, Aesch (CH); Andreas BÜCHIN, Lörrach (DE)

(21) Appl. No.: 15/781,846

(22) PCT Filed: Dec. 1, 2016
(86) PCT No.: PCT/EP2016/079478

§ 371 Date: Jun. 6, 2018

(30) Foreign Application Priority Data
Dec. 15, 2015 (DE) 10 2015 121 867.4

(51) Int. Cl. G05B 19/418

(52) U.S. Cl. CPC G05B 19/4186; G05B 2219/31138; G05B 2219/34263; G05B 2219/31368; G05B 2219/31135

(57) ABSTRACT

A computer-implemented method for providing a generic diagnosis model at a node of an automation network, wherein the automation network has multiple subordinate field bus segments, each having multiple field bus subscribers, connected to the node and the method comprises the following steps: provision of specific diagnosis information by the field bus subscribers of the respective field bus segment; combination of the specific diagnosis information provided by the field bus subscribers at the node; transfer of all combined diagnosis information to the generic diagnosis model, wherein the specific diagnosis information is additionally enriched with meta information, so that the generic diagnosis model can be used to access specific diagnosis information of the respective field bus subscriber.

The invention refers to a computer-implemented method for providing a generic diagnosis model at a node of an automation network and to a system of automation technology.

Field devices serving to capture and/or modify process variables are frequently used in process automation technology. Sensors, such as fill level measuring devices, flow meters, pressure and temperature measuring devices, pH-redox potential meters, conductivity meters, etc., are used for recording the respective process variables, such as fill level, flow, pressure, temperature, pH level, and conductivity. Actuators, such as, for example, valves or pumps, are used to influence process variables. The flow rate of a fluid in a pipeline section or a filling level in a container can thus be altered by means of actuators. Field devices, in general, refer to all devices which are process-oriented and which supply or process process-relevant information. A variety of such field devices are manufactured and marketed by the Endress+Hauser company.

In modern industrial plants, field devices in automation networks are usually connected with superordinate units via different fieldbus segments and/or bus systems. Examples of such fieldbus segments with different bus systems are Profibus®, Foundation® Fieldbus, HART®, etc.

Usually, the superordinate units are control systems and/or control units, such as e.g. SPC (Stored Program Control) or a PLC (Programmable Logic Controller). The superordinate units are used for, among other things, process visualization, process monitoring, process control, as well as for commissioning of the field devices. In order to optimize plant availability, modern facilities use diagnosis systems in the area of the individual field devices as well as occasionally comprehensively for subsegments or the entire plant. On the field device level, partly various features of the field device itself as well as characteristics of a process in which the field device is used are utilized to generate a diagnosis, monitored by the respective field unit and, if necessary, evaluated. The resulting diagnosis information is provided in the field device by means of appropriate parameters (also referred to as diagnosis parameters). The diagnosis information may be transmitted as diagnosis messages to a superordinate unit which requires the diagnosis information to execute its functions. The diagnosis messages that can be provided by a field unit usually differ according to fieldbus segment, field unit type, manufacturer, and often also depending on the unit version of the field device. For example, especially Profibus DP, Profibus PA and HART provide different diagnosis information in the most diverse formats and access methods. Consequently, the diagnosis messages a field device can provide are usually bus-specific diagnosis information.

In modern plants of process automation technology, several part segments are often linked in a network with different fieldbuses, which means that in a process automation technology plant, there is a high number of different pieces of diagnosis information available. However, the different diagnosis information from the various nodes in the network cannot be captured and/or interpreted uniformly by all subscribers, since their data structure, access method and synchronization mechanisms in time are different and/or not uniform/standardized. This makes it difficult, especially for a superordinate unit, to access diagnosis messages from field devices of different fieldbus segments. The available superordinate units are especially a condition monitoring unit, a human machine interface (abbreviated: HMI) and/or a SCADA system (abbreviation for supervisory control and data acquisition).

Only recently, unified diagnosis concepts have been developed that define unified diagnosis messages across field device types and/or fieldbuses. Such a diagnosis concept has been described in particular in the NAMUR recommendation NE 107. It defines four status signals (or four field device status categories) which respectively provide information about the status of the field device in question. For modern field devices corresponding to this NAMUR recommendation, the diagnosis messages created in a field device have to be classified exactly into one of those four field device status categories. On the basis of the field device status category, plant operators can quickly grasp the importance and relevance of any diagnosis message from a field device and take the necessary measures. Nevertheless, the basic problem remains that it is currently impossible for individuals to access the varied (fieldbus) specific diagnosis information in a harmonized and time-synchronized manner themselves.

Accordingly, the purpose of the invention is to propose an option to provide harmonized and time-synchronized access to all diagnosis information.

This task is solved according to the invention by a computer-implemented method to provide a generic diagnosis model as well as a system of automation technology.

With regard to the computer-implemented method, the task is solved by a computer-implemented method for providing a generic diagnosis model at a node of an automation network, wherein the automation network has multiple subordinate fieldbus segments, each having multiple fieldbus subscribers, connected to the node, and the method comprises the following steps:
providing specific diagnosis information by the field bus subscribers of the respective field bus segment;
combining, preferably time-related and/or content related combining, of the specific diagnosis information provided by the field bus subscribers at the node;
transferring of all combined diagnosis information to the generic diagnosis model, wherein the specific diagnosis information is additionally enriched with meta information, so that the generic diagnosis model can be used to access specific diagnosis information of the respective fieldbus subscriber, particularly access it in a unified and/or time-synchronized manner.

According to the invention, a genetic diagnosis model is proposed that provides a consolidated insight into the specific diagnosis information of the field devices in subordinate fieldbus segments for a unified transmission.

By enriching the meta information, the diagnosis model structure and the features of the diagnosis information are provided in a machine-readable format. This is particularly advantageous for Industry 4.0 scenarios.

The specific diagnosis information in question is to be understood as being information regarding the status of a field device. Such diagnosis information is defined as four field device status categories (maintenance requirement, outside of specification, function control and failure) pursuant to the Namur recommendation NE 107, each of the categories providing statements about the status of the respective field device. The diagnosis information comprise the device status, a text description and remedies to solve possible operating faults of the device. Such diagnosis information may be present as a short definition (ShortText) such as “field device corroded”. Suitable remedies such as “clean sensor with cleaning fluid” are already included in the diagnosis information.

Meta-information in the context of this invention refers to information that contains (additional) features about process values, but does not include the process values themselves. One example would be a field device with an engine that outputs the rotational speed of the motor as a process value. Then, meta-information would be, for example, the value range, the physical unit of the rotational speed, a maximum value or a minimum value.

By enriching the meta information, the diagnosis model structure and the features of the diagnosis information are provided in a machine-readable format. For this purpose, the secondary device information from the fieldbus subscribers is available in a structured manner (for example as per Namur recommendation NE 107), including additional error classification in the fieldbus subscribers. This information is read, e.g. using a gateway, and enriched with additional information that might be derived according to the error classification and the error standards NE 107. The additional information is, among others, a more precise error description and remedies for any errors found in the fieldbus subscriber. By means of an error source analysis, a fieldbus subscriber creates a priority list of the errors found. The meta-information then allows to display the high priority errors in order of priority as well as remedies for them.

According to an advantageous embodiment, a unit that is superordinate to the node is used to access the generic diagnosis model.

According to an advantageous embodiment, access from the superordinate unit to the node occurs via an OPC-UA protocol.

OPC-UA is a new standard protocol for communication independent of the manufacturer, especially in process automation, specified by the OPC Foundation. The original name for OPC was OLE for Process Control, but OPC is now used without any indication of an abbreviation. UA is the abbreviation of Unified Architecture. In the following, English terminology is frequently used as it describes special functions or specifications defined in the standard.

According to an advantageous embodiment, at least one Profibus DP, one Profibus PA, a HART, an Ethernet IP, Profinet or a Foundation fieldbus segment is used as the subordinate fieldbus segment.

According to an advantageous embodiment, the meta-information of the generic diagnosis model is used to access specific diagnosis information.

According to an advantageous embodiment, the specific pieces of diagnosis information are combined in the node via an OPC-UA protocol.

As far as the system is concerned, the aim is achieved via an automation technology system that comprises at least the following:
an automation network;
several fieldbus segments in the automation network with several fieldbus subscribers each, wherein the fieldbus participants of each fieldbus segment comprise specific diagnosis information;
a node in the automation network, wherein the fieldbus segments are connected with the node and the node is designed to execute the method according to one of the claims 1 to 6.

An advantageous embodiment of the system according to the invention further provides a system that has at least one superordinate unit which accesses the generic diagnosis model at the node via an OPC-UA protocol.

A further advantageous embodiment of the system according to the invention provides that the node comprises a gateway.

Another advantageous embodiment of the system according to the invention provides that the fieldbus segments have at least one Profibus DP, one Profibus PA or HART segment.

One advantageous embodiment of the system according to the invention provides that the specific diagnosis information provides at least one piece of specific Profibus DP, Profibus PA or HART diagnosis information.

An advantageous embodiment of the system according to the invention provides that the specific diagnosis information comprises information, especially diagnosis information pursuant to the NAMUR recommendation NE 107.

The invention is explained in more detail based upon the following drawing. Illustrated are:

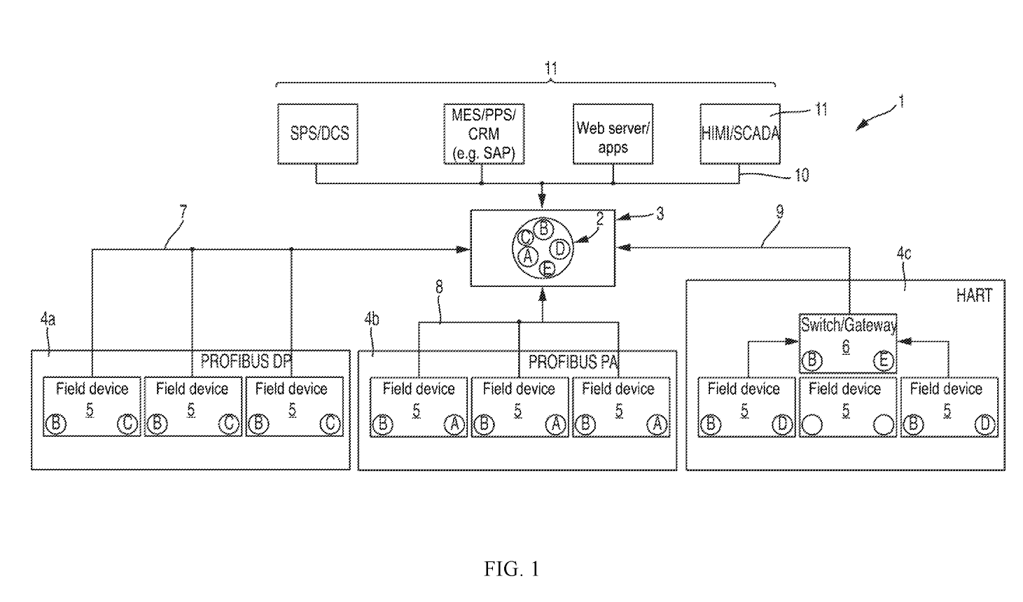

FIG. 1: a schematic illustration of an automation network to explain the method according to the invention.

FIG. 1 shows a schematic representation of an automation network 1 to explain the method according to the invention. The automation network 1 comprises three fieldbus segments 4a, 4b, 4c that are connected to several superordinate units 11 via a joint node 3.

A number of systems come into consideration as superordinate units, especially those that allow an OPC-UA connection to the node. For example, the superordinate unit may be a stored program control (abbreviated: SPC) and/or a process control system (abbrev.: PCS), a manufacturing execution system (abbrev.: MES), a production planning and control system (abbrev.: PPS), a customer relationship management system (abbrev.: CRM), a web server, a human-machine interface (abbrev.: HMI) and/or a supervisory control and data acquisition system (abbrev.: SCADA).

The superordinate unit and/or units is and/or are connected to the node via a fieldbus with OPC-UA protocol 10, so that the unit and/or units may access the central node. The node 3 in turn is connected with the different fieldbus segments via a fieldbus.

The first fieldbus segment 4a is a segment based on Profibus DP. Accordingly, the field units associated to the first fieldbus segment show specific Profibus DP diagnosis information.

The second fieldbus segment 4b is a segment based on Profibus PA. Accordingly, the field units associated to the second fieldbus segment show specific Profibus PA diagnosis information.

The third fieldbus segment 4b is a segment based on HART. Accordingly, the field units associated to the third fieldbus segment show specific HART diagnosis information. In case of the HART segment, the specific diagnosis information is processed in a switch and/or gateway, e.g. a remote I/O, before they are fed into the node. The switch and/or the gateway additionally comprise their own specific diagnosis information, e.g. physical network characteristics that are also fed into the node. The fieldbus-specific pieces of diagnosis information from the respective fieldbus subscribers are directly fed to the node from the Profibus DP and Profibus PA segments. As can be seen from FIG. 1, the fieldbus subscribers may have information B pursuant to the NAMUR recommendation NE 107 in addition to the bus-specific diagnosis information A, C, D or E. In such case, the specific diagnosis information hence comprises the bus-specific diagnosis information A, C, D or E and the diagnosis information B as per the NAMUR recommendation NE 107 (in the version as from Jun. 12, 2006).

The various specific diagnosis information to the node is fed in via an OPC-UA protocol. The node, which may be a gateway, processes and/or transforms the specific diagnosis information into a generic and/or unified diagnosis model and/or information model and synchronizes it in time. In this model, additional meta-information is added, so that superordinate units may access specific diagnosis information of the respective fieldbus subscriber and query the structure and/or features of the model and/or the information in an automated manner. The provision of meta-information via a central node allows many use cases for Industry 4.0, such as increased automation levels of the monitoring function of a system. Similarly, meta-information allows for automatic visualization of the specific diagnosis information.

### LIST OF REFERENCE SYMBOLS

1 Automation network
2 Generic diagnosis model
3 Node
4a First fieldbus segment, especially Profibus DP segment
4b Second fieldbus segment, especially Profibus PA segment
4c Third fieldbus segment, especially HART segment
5 Field device
6 Switch/Gateway of the HART segment
7 Profibus DP fieldbus
8 Profibus PA fieldbus
9 HART fieldbus
10 Fieldbus with OPC-UA protocol
11 Superordinate unit
A, B, C, D, E Specific diagnosis information

1-12. (canceled)

13. A computer-implemented method to provide a generic diagnosis model, comprising:
providing an automation network including a node and multiple subordinate field bus segments connected to the node, each subordinate field bus segment including multiple field bus subscribers;
providing to the node specific diagnosis information by the field bus subscribers of the respective field bus segment;
combining the specific diagnosis information provided by the field bus subscribers at the node;
transferring the combined diagnosis information to a generic diagnosis model; and
enriching the specific diagnosis information with meta information so that the generic diagnosis model can be used to access the specific diagnosis information of the respective field bus subscriber.

14. The method according to claim 13, wherein the generic diagnosis model is accessed by a unit that is superordinate to the node.

15. The method according to claim 14, wherein access from the superordinate unit to the node occurs via an OPC-UA protocol.

16. The method according to claim 13, wherein the multiple subordinate fieldbus segments includes at least a Profibus DP, a Profibus PA, or a HART segment.

17. The method according to claim 13, wherein the meta information of the generic diagnosis model is used to access specific diagnosis information.

18. The method according to claim 13, wherein the specific diagnosis information is combined at the node via an OPC-UA protocol.

19. An automation technology system, comprising:
an automation network;
several fieldbus segments in the automation network, each fieldbus segment including several fieldbus subscribers, wherein the fieldbus subscribers of each fieldbus segment include specific diagnosis information; and
a node in the automation network, wherein the fieldbus segments are connected with the node and the node is configured to
receive the specific diagnosis information from the plurality of subscribers,
transfer the received specific diagnosis information to a generic diagnosis model,
combine the received specific diagnosis information at the node,
enrich the received specific diagnosis information with meta information,
communicate with a superordinate unit via an OPC-UA protocol, and
communicate with the fieldbus segments with at least a Profibus DP protocol, a Profibus PA protocol, or a HART protocol.

20. The automation technology system according to claim 19, further comprising:
at least one superordinate unit configured to access the generic diagnosis model at the node via an OPC-UA protocol.

21. The automation technology system according to claim 19, wherein the node includes a gateway.

22. The automation technology system according to claim 19, wherein the fieldbus segments include at least one of the following: a Profibus DP, a Profibus PA, a HART, an Ethernet IP, a Profinet and a Foundation fieldbus segment.

23. The automation technology system according to claim 19, wherein the specific diagnosis information includes at least one Profibus DP, one Profibus PA or one HART specific diagnosis information.

24. The automation technology system according to claim 19, wherein the specific diagnosis information includes information pursuant to the NAMUR recommendation N 107.
